(19) United States
(12) Patent Application Publication
(10) Pub. No.: US 2026/0140008 A1
(43) Pub. Date: May 21, 2026

(54) METHOD FOR INTELLIGENT DETERMINATION OF BEAM TOWER ALIGNMENT AND SUSPENSION CABLE TENSIONING OF HYBRID CABLE-STAYED SUSPENSION BRIDGE

(71) Applicants: Guangxi University, Nanning (CN); Changsha University of Science & Technology, Changsha (CN); Guangxi Transportation Science and Technology Group CO., LTD, Nanning (CN); Hunan Dexi Xiangdong Technology Co., LTD, Changsha (CN)

(72) Inventors: Chuanxi LI, Nanning (CN); Zhi SHI, Changsha (CN); Zheng FENG, Nanning (CN); Chuangwen DONG, Changsha (CN); Guibing XIANG, Nanning (CN); Lu KE, Nanning (CN)

(21) Appl. No.: 19/446,880

(22) Filed: Jan. 12, 2026

(30) Foreign Application Priority Data
Aug. 20, 2025 (CN) 202511166019.8

(51) Int. Cl. G01M 5/00; E01D 19/16; G06F 30/23; G06F 119/14

(52) U.S. Cl. CPC G01M 5/0008; E01D 19/16; G06F 30/23; G06F 2119/14

(57) ABSTRACT

A method for intelligent determination of beam tower alignment and suspension cable tensioning of a hybrid cable-stayed suspension bridge. Construction steps are formulated. Element division and node numbering are performed. Initial value assignment is performed A first-stage structure including weightless beam elements is established. A structural model for each construction phase is established. Calculation is performed until the bridge completion or 10 years after the bridge completion. Internal forces under variable loads in the bridge completion state are calculated and combined. Whether bearing capacities during a construction phase and of the completed bridge meet design and specification requirements is determined. Completed-bridge coordinate values of beam element nodes are calculated. Beam tower alignment is judged. Main cable alignment verification calculation is performed. Stress-free coordinates and installation coordinates for beam-tower nodes are determined based on final coordinate model values and displacement of corresponding nodes to installation time. Safety inspection is performed.

### CROSS-REFERENCE TO RELATED APPLICATIONS

This application claims the benefit of priority from Chinese Patent Application No. 202511166019.8, filed on Aug. 20, 2025. The content of the aforementioned application, including any intervening amendments made thereto, is incorporated herein by reference in its entirety.

### TECHNICAL FIELD

This application relates to bridge construction, and more particularly to a method for intelligent determination of beam tower alignment and suspension cable tensioning of a hybrid cable-stayed suspension bridge.

### BACKGROUND

The modern cable-stayed suspension cooperative system is a type of bridge with an overlapping-segment that integrates both cable-stayed and suspension sections. Owing to its ability to mitigate fatigue in the end of hangers, as well as its advantages in spanning capacity, stiffness, and wind resistance compared to conventional cable-stayed bridges, this structural system has undergone rapid development in recent years.

Determination of reasonable construction stages for the cable-stayed suspension cooperative system bridges involves determining the manufacturing lines for prefabricated components (or stress-free lines), installation lines, formwork lines for cast-in-place elements, construction procedures, and the cable tension forces (or stress-free lengths) at each stage. These measures are essential to ensure structural safety throughout construction and in the completed bridge, as well as to achieve the designed alignment of the finished structure. The determination of the reasonable construction state is a critical aspect in both the design and construction monitoring calculations of hybrid cable-stayed suspension bridges, and constitutes one of the core tasks in ensuring the realization of target alignment and safety objectives, while optimizing construction processes and methodologies.

In existing approaches, which assume that the main beam attains its rational completed state in a single continuous process (i.e. the single-step bridge formation method), when the structure is disassembled back to the closure state, the displacement difference (including angular difference) at the nodes on both sides of the closure section must be zero. This is because, from the closure state through to the completed bridge and back to the initial structure, the displacement coupling at the closure section nodes is typically non-zero. Moreover, the internal forces at the closure section are generally not zero. As the structure transitions from the closure state to the state just before closure, a displacement difference inevitably arises due to the decoupling of the nodes on either side of the closure section and the change in sectional internal forces from non-zero to zero. If this displacement difference exceeds the allowable value and the closure section is installed directly, issues such as misalignment, angular deviation, improper weld width, and deviation from the intended completed state may occur. If forced measures are applied to make the displacement difference (both linear and angular) zero before welding or bolting the closure section, the ideal bridge completion state of the main beam formed in a single step can be fully achieved.

Hence, under the assumption that the main beam is formed in a single continuous process, it is reasonable to require that the displacement difference at the closure section remains within permissible limits. However, the assumption of single-step bridge formation, which does not align with actual construction practices, is debatable. Consequently, forcing closure under such unrealistic conditions inevitably leads to complicated installation and jointing measures. For instance, suspended beam segments may need to be hinged to bear loads initially, and segments on both sides of the closure section may need to be stressed independently first. Such practices are likely to result in deviations between the actual bridge completion state (including alignment) and the ideal state achieved by single-step bridge formation, thereby failing to ensure that the final bridge geometry matches the designed alignment. In response to these challenges, this application proposes a method for intelligent determination of beam tower alignment and low-carbon (with efficient construction and good economic benefits) suspension cable tensioning of a hybrid cable-stayed suspension bridge, so as to address the above issues effectively.

### SUMMARY

Based on this, in order to solve the problems in the prior art, the present application provides a method for intelligent determination of beam tower alignment and suspension cable tensioning of a hybrid cable-stayed suspension bridge, comprising:
(1) based on a stage-by-stage bridge construction internal logic according to a background engineering project, selecting a position of a closure section, and formulating construction steps;
(2) based on the construction steps, performing element division and node numbering on a bridge structure;
(3) assigning corresponding values of a stress-free structure under a bridge completion state achieved by single-step bridge formation as initial values of coordinates of beam element nodes and stress-free lengths of main cable segments, hangers and stay cables;
(4) based on the stress-free lengths of the main cable segments and the coordinates of the beam element nodes, establishing a first-stage structure comprising weightless beam elements, wherein the weightless beam elements comprise main beam elements, tower elements and the main cable elements;
during installation of a prefabricated beam-end segment in a cable-stayed portion, simultaneously installing weightless beam elements of remaining beam segments in the cable-stayed portion bounded by the closure section;
during installation of a prefabricated beam-end segment of a suspension area, simultaneously installing weightless beam elements of remaining beam segments in the suspension area bounded by the closure section; and
during installation of a first prefabricated tower segment, simultaneously installing weightless beam elements of remaining tower segments of the bridge tower;
(5) for all stages except the first-stage structure, performing application of main beam weights, tensioning of the stay cables, tensioning of the hangers, hinged and rigid connections of beam segments and rigid connection of main beams on both sides after closure according to the construction steps, ensuring that weightless beam elements remain statically determinate under a weightless condition;
(6) performing formal calculation on beam closure according to the construction steps;
(7) determining whether a displacement difference between nodes on both sides of the closure section immediately prior to closure is less than a first allowable value;
(8) performing calculation from a closure moment to bridge completion or up to 10 years after the bridge completion;
(9) calculating and combining internal forces under variable loads in the bridge completion state;
(10) determining whether a bearing capacity during a construction phase and a bearing capacity of a completed bridge meet design and specification requirements;
(11) calculating bridge coordinate values for the beam element nodes, wherein a calculated coordinate of one of the beam element nodes is equal to a latest coordinate model value of a corresponding node plus a cumulative displacement value of the corresponding node;
(12) determining whether a deviation between calculated coordinates and design values of the beam element nodes is less than a second allowable value;
(13) based on the bridge bearing capacity of the completed bridge, the calculated coordinates of the beam element nodes, and the stress-free lengths of the main cable segments, performing, by using a suspension cable subsystem, form-finding calculation on the main cable to obtain a calculated sag of the main cable in the bridge completion state; and calculating a difference between a designed sag and the calculated sag of the main cable, and determining whether the difference between the designed sag and the calculated sag is greater than a third allowable value;
(14) determining stress-free coordinates and installation coordinates of beam tower nodes based on final coordinate model values and a corresponding node displacement to an installation time; and
(15) performing variable load effect calculation, internal force combination and verification.

In some embodiments, step (3) comprises:
determining, by using a simply-supported beam method or a rigid supported continuous beam method, a vertical force component of a dead load in the bridge completion state acting on lower ends of stay cables in a main span; and independently solving, by using the suspension cable subsystem, other geometric and mechanical parameters of the stay cables in the main span;
determining a horizontal force component of the dead load acting on upper ends of stay cables in a side span as equal to a horizontal force component of the dead load in the bridge completion state acting on the stay cables in the main span intersecting a centerline of the bridge tower; and independently solving, by using the suspension cable subsystem, other geometric and mechanical parameters of the stay cable in the side span;
according to a distribution ratio of the dead load shared by the hangers and the stay cables, determining a vertical force at lower ends of hangers in an overlapping-segment; and determining, by using a simply-supported beam method, a counterweight on the main beam in a cable-stayed section and the overlapping-segment of the side-span and dead load cable forces of the hangers in the main span and the side span in the bridge completion state;
based on a vertical sag of the main span and a condition that a resultant of horizontal force components of the main cables in the main span and the side span borne by the bridge tower is zero, determining geometric and mechanical parameters of the main cable and the hangers in the completed bridge dead load state of the main span and the side span; performing form-finding of the main cable and calculation of stress-free lengths of the cable segments and the hangers in the bridge completion state in accordance with the suspension cable subsystem; and
integrating the stress-free lengths of the cable segments, the hangers and the stay cables of the main cable into an overall model of a continuous structure with a dead load and a weightless main beam; and determining, through an iterative method, the stress-free lengths of the hangers and the stay cables, as well as coordinate model values of the beam element nodes to achieve completed-bridge design alignment for the main beam and the bridge tower.

In some embodiments, the step of performing form-finding of the main cable and calculation of the stress-free lengths of the cable segments and the hangers in the bridge completion state in accordance with the suspension cable subsystem comprises:
(a) based on design values of coordinates of lower anchor points of the hangers, vertical force components at the lower anchor points and initial coordinates of upper anchor points of the hangers, calculating the stress-free lengths of the hangers and the cable forces at the upper anchor ends according to a catenary theory, and determining concentrated forces acting on the main cable nodes considering a weight of a cable clamp;
(b) based on the concentrated forces, mid-span elevation, material properties and cross-sectional dimensions, calculating, by using an analytical method, coordinates of each main cable node and the stress-free length of each cable segment;
(c) based on latest coordinates of the upper anchor points at each main cable node, the design values of the lower anchor points for each hanger and latest vertical component forces at the lower anchor points, recalculating the stress-free length of each hanger, the cable force at the upper anchor end, and the concentrated forces acting on each main cable node; and
(d) repeatedly performing steps (a)-(c), after each iteration, calculating a difference between coordinates of each node of the main cable obtained in the latest time and coordinates of the same nodes obtained in the previous time, and determining whether the difference is less than a fourth allowable value.

In some embodiments, the step of determining whether coordinates of each node of the main cable obtained in the latest time and coordinates of the same nodes obtained in the previous time comprises:
if the difference is less than the fourth allowable value, adopting the latest values of stress-free lengths the hangers and main cable segments as final design values; and
if the difference is greater than the fourth allowable value, repeating step (b).

In some embodiments, the steps of determining, through the iterative method, the stress-free lengths of the hangers and the stay cables, as well as coordinate model values of the beam element nodes to achieve completed-bridge design alignment for the main beam and the bridge tower comprises:
(a) assigning initial values to the stress-free coordinates of the beam element nodes and the stress-free lengths of the hangers and the stay cables, as well as the vertical force components at the lower ends of the hangers in the finite element model of the entire bridge;
(b) calculating a structural response of the finite element model under the single-step bridge formation considering member self-weight and secondary dead load to obtain internal forces of elements and nodal displacements;
(c) calculating a difference between the latest vertical force components at the lower ends of the hangers under the completed-bridge dead load and previous values, and determining whether the difference is less than a fourth allowable value;
(f) adding the latest stress-free coordinates of the bridge tower and the main beam nodes to the node displacement to obtain the calculated completed-bridge bridge coordinates of the nodes;
(g) determining a correction amount of the stress-free coordinates of the beam element nodes by subtracting the calculated bridge-completed coordinates from the designed bridge-completed coordinates, and determining whether the correction amount is less than a fifth allowable value.

In some embodiments, step (a) comprises:
assigning the bridge coordinate design values of the beam element nodes as initial values node coordinates in the finite element model;
assigning the stress-free lengths of the stay cables, the stress-free lengths of the hangers, and the stress-free lengths of the main cable segments obtained under the suspension cable subsystem as initial values of corresponding stress-free cable lengths in the finite element model; and
determining vertical forces at the lower ends of the hangers by the rigid supported continuous beam method and the distribution ratio of dead load between the stay cables and the hangers in the overlapping-segment as initial values of the vertical force components at the lower ends of the hangers for subsequent calculations.

In some embodiments, the step of determining whether the difference between the latest vertical force components at the lower ends of the hangers under the completed-bridge dead load and previous values comprises:
(d) if the difference is less than the fourth allowable value, adding the latest stress-free coordinates of the bridge tower and main beam nodes to the node displacement to obtain calculated bridge coordinates of the nodes; and
(e) if the difference is greater than the allowable value, recalculating the stress-free length of the main cable segments and the stress-free length of the hangers according to the calculation steps for the form-finding of the main cable and the stress-free length of each cable segment and hanger in the bridge completion state under the suspension cable subsystem.

In some embodiments, the step of determining whether the correction amount of the stress-free coordinates of the beam element nodes by subtracting the calculated bridge-completed coordinates from the designed bridge-completed coordinates is less than the fifth allowable value comprises:
(h) if the correction amount is less than the fifth allowable value, adopting the latest stress-free coordinates of the beam element nodes and latest stress-free lengths of the hangers and the stay cables as the final stress-free coordinates of the beam element nodes and the stress-free lengths of the hangers and the stay cables required to achieve final completed-bridge design alignment under the single-step bridge formation with the dead load; and
(i) if the correction amount is greater than the fifth allowable value, adding the correction amount to the previous stress-free coordinates to obtain the latest stress-free coordinates of the beam element nodes, and calculating latest stress-free lengths of the hangers and the stay cables according to the suspension cable subsystem based on an unchanged cable force at the lower end of each cable and the latest stress-free coordinates at the two endpoints of the cable.

In some embodiments, step (7) comprises:
if the displacement difference is less than the first allowable value, proceeding internal force calculation and combination under variable loads until the bridge completion or up to 10 years after the bridge completion followed by strength determination; and
if the displacement difference is greater than the first allowable value, adjusting the closure section and repeating steps of forming the structural model.

In some embodiments, step (10) comprises:
if the requirements are met, calculating the coordinates of the beam element nodes; and
if the requirements are not met, adjusting the construction steps or tensioning forces of the hangers and the stay cables, and repeating the step of forming the first-stage structure using weightless beam elements.

In some embodiments, step (12) comprises:
if the deviation is less than the second allowable value, performing main cable completed-bridge alignment verification calculation; and
if the deviation is greater than the second allowable value, calculating a correction amount of model coordinate values of the beam element nodes, wherein the correction amount is equal to a design value of a completed bridge coordinate of a corresponding one of the beam element nodes minus the latest calculated value of the completed bridge coordinate of the corresponding one of the beam element nodes, then calculating a latest coordinate model value by adding the correction amount to a previous coordinate model value of the corresponding one of the beam element nodes; based on the latest coordinate model value and the vertical force components at the lower ends of the hangers and the stay cables, adjusting the stress-free lengths of the hangers and the stay cables, and repeating the step of forming the first-stage structure using weightless beam elements.

In some embodiments, the step of determining whether the difference between the calculated sag and the designed sag is greater than the third allowable value comprises:
if the difference is less than the allowable value, determining installation coordinates; and
if the difference is greater than the allowable value, based on the latest suspension cable force, the coordinates of the anchor points, and the designed sag in the bridge completion state, recalculating the stress-free lengths of the main cable segments using the suspension cable subsystem, and repeating the step of forming the first-stage structure comprising the weightless beam elements.

Compared to the prior art, the present disclosure has the following beneficial effects.

By adopting the method of the present disclosure, not only can the ideal competed-bridge alignment of the main beam be ensured to be consistent with the designed alignment, but also the closure measures and the removal process after closure are eliminated, which further improves the calculation efficiency and makes the determination process of the beam tower alignment and the tension of the suspension cable more intelligent.

### BRIEF DESCRIPTION OF THE DRAWINGS

In order to provide a clearer explanation of the embodiments of the present disclosure or the technical solutions in the prior construction method, a brief introduction will be given to the accompanying drawings required for the description of the embodiments or the prior construction method. It is obvious that the accompanying drawings described below are only some embodiments of the present disclosure.

For those skilled in the construction method, other drawings can be obtained based on the structures shown in these drawings without creative labor.

FIG. 1 is a flowchart of a method for intelligent determination of beam tower alignment and suspension cable tensioning of a hybrid cable-stayed suspension bridge in Embodiment 1 of the present disclosure;

FIG. 2 is a flowchart of a method for intelligent determination of beam tower alignment and suspension cable tensioning of a hybrid cable-stayed suspension bridge in Embodiment 2 of the present disclosure;

FIG. 3 shows layout of bridge type and finite element model of an entire bridge for tower formwork of a cable-stayed suspension cooperative system of the present disclosure;

FIG. 4 shows positional relationship between a main beam segment, hangers, and stay cables of the tower formwork of the hybrid cable-stayed suspension bridge according to the present disclosure;

FIG. 5 shows position diagram of a closure section of the tower formwork of the hybrid cable-stayed suspension bridge of the present disclosure;

FIG. 6 is a schematic diagram of a vertical support reaction force of a main beam model of the tower formwork of the hybrid cable-stayed suspension bridge of the present disclosure; and

FIG. 7 shows form-finding analysis model diagram of the main cable for the tower formwork of the hybrid cable-stayed suspension bridge of the present disclosure.

The implementation, functional characteristics, and advantages of the present disclosure will be further explained with reference to the accompanying drawings in conjunction with the embodiments.

### DETAILED DESCRIPTION OF EMBODIMENTS

Technical solutions in the embodiments of the present disclosure will be clearly and completely described below in conjunction with the accompanying drawings. Obviously, the described embodiments are only some of the embodiments of the present disclosure, not all of them. Based on the embodiments of the present disclosure, all other embodiments obtained by those of ordinary skilled in the art without creative labor shall fall within the protection scope of the present disclosure.

It should be noted that all directional indications (such as up, down, left, right, front, back, etc.) in the embodiments of the present disclosure are only used to explain the relative position relationship, motion, etc. between the components in a specific posture (as shown in the attached figure). If the specific posture changes, the directional indication will also change accordingly.

In addition, the description of “first”, “second”, etc. in the present disclosure is for descriptive purposes only and cannot be understood as indicating or implying their relative importance or implying the number of technical features indicated. Therefore, the features that are limited to “first” and “second” can explicitly or implicitly include at least one of these features. In addition, the term “and/or” in the entire text includes three solutions, taking A and/or B as an example, including technical solution A, technical solution B, and technical solutions that both A and B meet simultaneously. In addition, the technical solutions between various embodiments can be combined with each other, but they must be based on the ability of ordinary technical personnel in this field to implement them. When the combination of technical solutions is contradictory or impossible to implement, it should be considered that this combination of technical solutions does not exist and is not within the scope of protection required by the present disclosure.

It should be noted that the single-step bridge formation method in the present disclosure is a method in the prior art. Method 1 is a method for determining reasonable construction and bridge completion status based on the allowable displacement difference of the closure section in the present disclosure. Method 2 of the present disclosure, addresses the deficiency of relatively complex erection and closure measures caused by the strict closure conditions in Method 1 of the present disclosure. Starting from the essence of the main beam being formed in multiple stages, Method 2 eliminates the calculation of measures required to meet the strict closure conditions and adopts a reasonable construction and bridge completion state determination method corresponding to phased formation of the main beam.

In the specification of this disclosure, the allowable values for displacement discrepancy, coordinate discrepancy, sag discrepancy, and length discrepancy are all set at 5 mm or 10 mm, while the allowable value for cable force discrepancy is set at 5 kN or 10 kN.

### Method 1

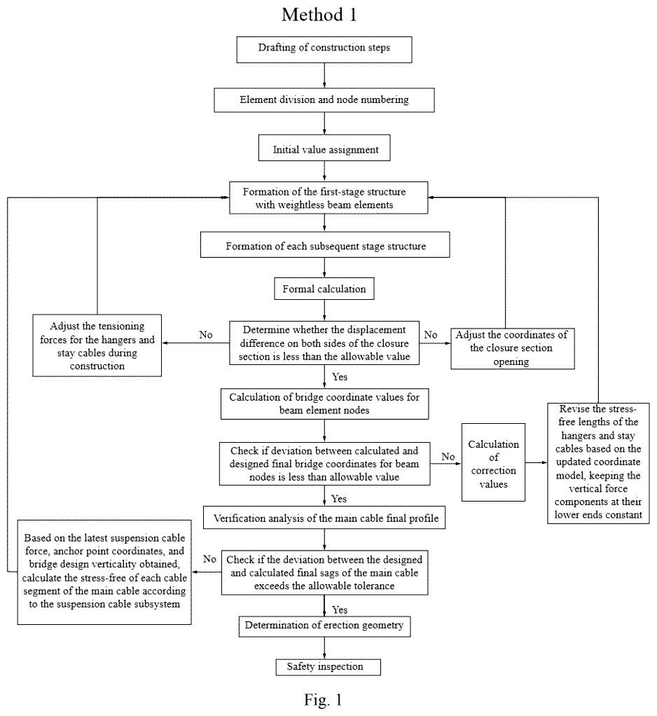

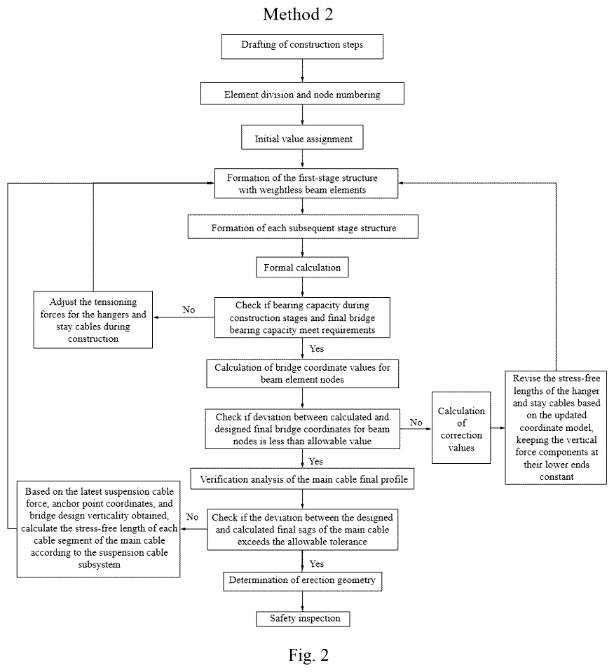

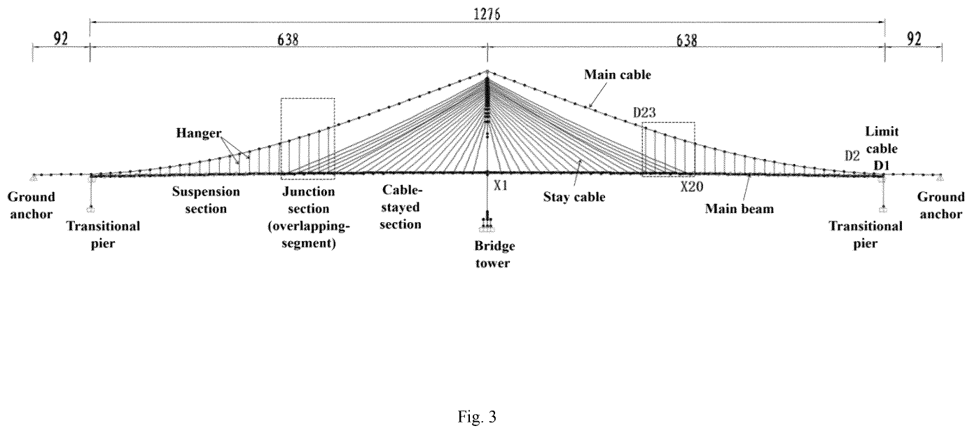

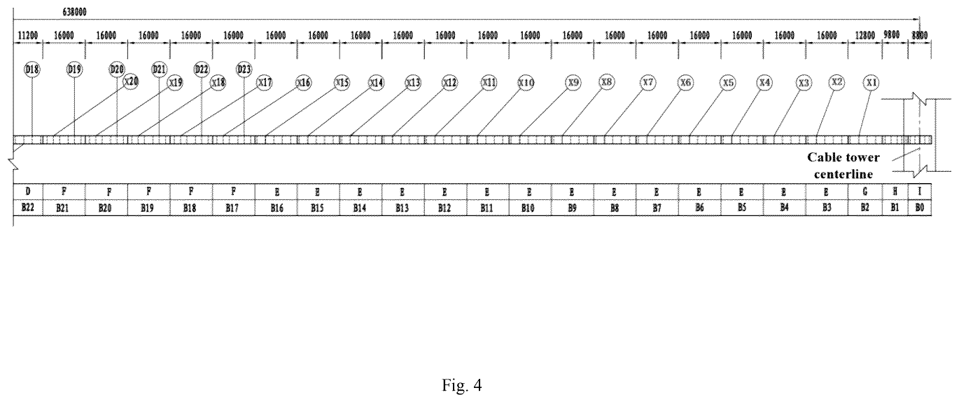

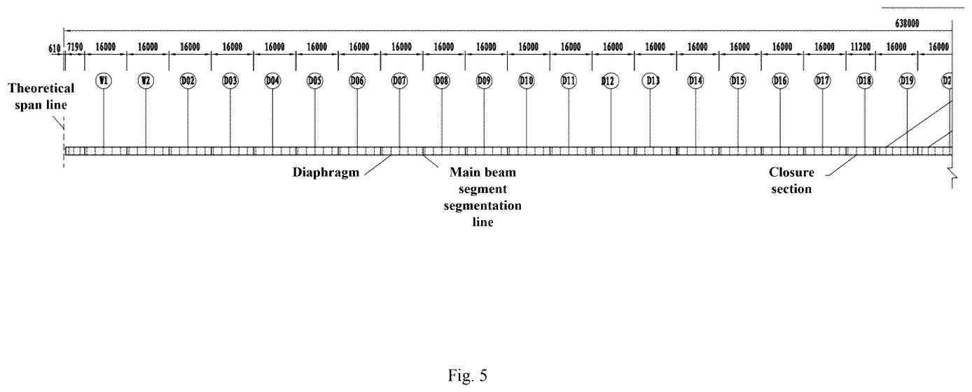

As shown in FIGS. 1-5, the present application provides a method for intelligent determination of beam-tower alignment and suspension cable tensioning of a hybrid cable-stayed suspension bridge, including the following steps.

(S1) Formulation of construction steps: Based on a stage-by-stage bridge construction internal logic according to a background engineering project, a position of a closure section is selected, and construction steps are formulated for reasonable construction and a bridge completion state where a displacement difference of the closure section does not exceed an allowable value.

(S2) Bridge tower formwork: Element division and node numbering are performed according to the construction steps. Initial value assignment is performed, and a structure of each stage of an entire bridge is formed.

(S3) Formal calculation: A displacement difference between nodes on both sides of the closure section according to the construction steps immediately prior to closure, and whether the displacement difference between the nodes on both sides of the closure section is less than the allowable value is determined.

Subsequent formal calculation: Calculation is performed from a closure moment to bridge completion or up to 10 years after the bridge completion.

Internal force combination of completed bridge: Internal forces under variable loads in the bridge completion state are calculated and combined.

Specifically, if the displacement difference is less than the allowable value, the calculation proceeds until the bridge completion or up to 10 years after the bridge completion, and the internal forces under the variable loads are calculated and combined. Then, strength determination of Step (S4) is performed. The selection of the bridge completion or 10 years after the bridge completion is determined by a target time for the beam-tower alignment specified in a design drawing. If unspecified, 10 years after the bridge completion is selected.

If the displacement difference is greater than the allowable value, the closure section is adjusted, and the step of forming the structure of each stage is repeated.

(S4) Strength determination: Whether a bearing capacity during a construction phase and a bearing capacity of the completed bridge meet design and specification requirements is determined.

In this step, the criteria for checking the bearing capacity during the construction phase and that of the completed bridge are as follows: Whether the calculated design internal forces for various sections do not exceed a bearing capacity of a corresponding section is determined. The bearing capacity of the completed bridge is deemed met if the design internal forces under the most unfavorable combination in the bridge completion state do not exceed the bearing capacity of each corresponding section. Otherwise, the requirements are not satisfied.

Specifically, if the requirements are met, coordinates of beam element nodes in the bridge completion state are calculated.

If the requirements are not met, the construction steps or tensioning forces of hangers and stay cables are corrected, and the first stage structural steps with weightless beam elements are repeated again. The adjustment of the construction steps can be determined according to an influence matrix method.

(S5) Calculation of bridge coordinate values for beam element nodes: Calculated values of the coordinates of the beam element nodes are equal to a latest model coordinate value of a corresponding node plus a cumulative displacement value of the corresponding node.

That is, calculated coordinate of the beam element nodes in the bridge completion state=latest coordinate model value+cumulative node displacement.

(S6) Determination of beam-tower alignment: Whether a deviation between the calculated coordinates of the beam element nodes and the design values is less than an allowable value.

Specifically, if the deviation is less than the allowable value, main cable completed-bridge alignment verification calculation is performed.

If the deviation is greater than the allowable value, a correction amount of model coordinate values of the beam element nodes is calculated. The correction amount is equal to the design value of the coordinate of the corresponding node minus the latest calculated value of the coordinate of the corresponding node, and then a new coordinate model value is obtained by adding the coordinate model value of the beam element node to the correction amount. Based on the new coordinate model value and keeping vertical force components at lower ends of the hangers and the stay cables unchanged, a stress-free length of an anchorage of the hanger and stay cable is corrected, and the first stage structural step of forming a weightless beam element is repeated again.

That is: Coordinate model value correction amount=Bridge coordinate design value-Bridge coordinate calculation value.

(S7) Main cable alignment verification calculation: Based on the obtained bridge bearing capacity, the coordinates of the beam element nodes in the bridge completion state, and the stress-free length of the main cable segments, a form-finding calculation of the main cable is performed using a hanger subsystem to determine a calculated sag of the main cable in the bridge completion state. A difference between the designed sag and the calculated sag of the main cable in the bridge completion state is then calculated, and whether the difference exceeds an allowable value is determined.

Specifically, if the difference is less than the allowable value, steps of determining installation coordinates are performed.

If the difference is greater than the allowable value, based on the latest suspension cable force, the coordinates of the anchor points, and the designed sag in the bridge completion state, the stress-free lengths of the main cable segments are recalculated using the suspension cable subsystem. Then, the step of forming the first-stage structure which includes the weightless beam elements is repeated.

(S8) Stress-free coordinates and installation coordinates for beam-tower nodes are determined based on the final coordinate model values and a corresponding node displacement to an installation time.

Installation coordinate (i.e., the latest stress-free coordinate values) of a rod end=the latest obtained coordinate model value+the displacement of that node (rod end) up to the installation time (up to bridge completion or 10 years after the bridge completion).

(S9) Safety inspection: Variable load effect calculation, internal force combination and verification are performed.

### Method 2

On the basis of the determination steps in Method 1, the step of determining whether the displacement difference between the nodes on both sides of the closure section is less than the allowable value is omitted, and the next step of strength determination is not performed. The remaining steps are consistent with the main steps and sub-steps of Method 1. That is, this application also provides a method for intelligent determination of beam-tower alignment and suspension cable tensioning of a hybrid cable-stayed suspension bridge, including the following steps.

(S1) Formulation of construction steps: Based on a stage-by-stage bridge construction internal logic according to a background engineering project, a position of a closure section is selected, and construction steps are formulated for reasonable construction and a bridge completion state where a displacement difference of the closure section does not exceed an allowable value.

(S2) Bridge tower formwork: Element division and node numbering are performed according to the construction steps. Initial value assignment is performed, and a structure of each stage of an entire bridge is formed.

(S3) Formal calculation: Calculation is performed until the bridge completion or 10 years after the bridge completion.

Internal force combination of completed bridge: Internal forces under variable loads in the bridge completion state are calculated and combined.

(S4) Strength determination: Whether a bearing capacity during a construction phase and a bearing capacity of the completed bridge meet design and specification requirements is determined.

In this step, the criteria for checking the bearing capacity during the construction phase and that of the completed bridge are as follows: Whether the calculated design internal forces for various sections do not exceed a bearing capacity of a corresponding section is determined. The bearing capacity of the completed bridge is deemed met if the design internal forces under the most unfavorable combination in the bridge completion state do not exceed the bearing capacity of each corresponding section. Otherwise, the requirements are not satisfied.

Specifically, if the requirements are met, coordinates of beam element nodes in the bridge completion state are calculated.

If the requirements are not met, the construction steps or tensioning forces of hangers and stay cables are corrected, and the first stage structural steps with weightless beam elements are repeated again. The adjustment of the construction steps can be determined according to an influence matrix method.

(S5) Calculation of completed-bridge coordinate values of beam element nodes:

Calculated values of the coordinates of the beam element nodes are equal to a latest model coordinate value of a corresponding node plus a cumulative displacement value of the corresponding node.

That is, calculated coordinate of the beam element nodes in the bridge completion state=latest coordinate model value+cumulative node displacement.

(S6) Determination of beam-tower alignment: Whether a deviation between the calculated coordinates of the beam element nodes and the design values is less than an allowable value.

Specifically, if the deviation is less than the allowable value, main cable completed-bridge alignment verification calculation is performed.

If the deviation is greater than the allowable value, a correction amount of model coordinate values of the beam element nodes is calculated. A new coordinate model value is obtained by adding the coordinate model value of the beam element node to the correction amount. Based on the new coordinate model value and keeping vertical force components at lower ends of the hangers and the stay cables unchanged, a stress-free length of an anchorage of the hanger and stay cable is corrected, and the first stage structural step of forming a weightless beam element is repeated again.

That is: Coordinate model value correction amount=Bridge coordinate design value-Bridge coordinate calculation value.

(S7) Main cable alignment verification calculation: Based on the obtained bridge bearing capacity, the coordinates of the beam element nodes in the bridge completion state, and the stress-free length of the main cable segments, a form-finding calculation of the main cable is performed using a suspension cable subsystem to determine a calculated sag of the main cable in the bridge completion state. A difference between the designed sag and the calculated sag of the main cable in the bridge completion state is then calculated, and whether the difference exceeds an allowable value is determined.

Specifically, if the difference is less than the allowable value, steps of determining installation coordinates are performed.

If the difference is greater than the allowable value, based on the latest suspension cable force, the coordinates of the anchor points, and the designed sag in the bridge completion state, the stress-free lengths of the main cable segments are recalculated using the suspension cable subsystem. Then, the step of forming the first-stage structure which includes the weightless beam elements is repeated.

(S8) Stress-free coordinates and installation coordinates for beam-tower nodes are determined based on the final coordinate model values and the displacement of the corresponding nodes to the installation time.

Installation coordinate of a rod end=the latest obtained coordinate model value+the displacement of that node (rod end) up to the installation time.

(S9) Safety inspection: Variable load effect calculation, internal force combination and verification are performed.

In this embodiment, a single tower hybrid cable-stayed suspension bridge with a main span of 2×638 m is adopted as the background engineering project. The main cable span is arranged as 2×730 m, and 20 pairs of stay cables (numbered sequentially from X1 to X20 from short cables to long cables) are set on each side of the cable tower. Twenty-two pairs of ordinary hangers (numbered sequentially from D2 to D23 from short cables to long cables) are set, and a limit cable (numbered D1) is arranged at the transition pier. The stay cables are arranged in a fan shape. A longitudinal anchorage spacing between the hangers and the cable-stayed beam is 16 m, and a staggered spacing between the cross-sections is 8 m. A length of the main beam in a single span cable-stayed area is 327 m, and a length of the main beam in a cable-stayed area is 383 m. The main cable is a spatial force system that gradually expands from the top of the tower to the ground anchor, and the hanger tilts horizontally across the bridge. The main beam is provided with transverse wind resistant bearings and longitudinal limit bearings at the cable tower, and vertical bearings and transverse wind resistant bearings are installed between the main beam and the transition pier. The main beam adopts a closed steel box reinforced beam type, with a height of 3 m and a width of 32.4 m.

The main cable is made and erected using an aerial spinning (AS) method, which has a longer construction period than the total construction period of this bridge. Therefore, saving construction time as much as possible is an important control factor in determining the closure plan of this bridge. The installation of the main beam and the construction of the main cable in the cable-stayed section of this bridge can be performed simultaneously. When the main beam of the suspension section starts to be hoisted, the main beam of the cable-stayed section has been basically installed. The closure section of the main beam is set at the junction section (overlapping-segment) and the suspension section, that is, the junction between the main beam segments B22 and B21 that are located between the hanger D18 and the stay cable X20, which can save construction time. Therefore, this location is determined as the position where the closure section of the main beam is located.

There are a total of 172 hangers and stay cables for the entire bridge. Each main cable is fixed to the ground or tower top at its inflection points (IP points) at both ends. The main cable is divided into 184 suspension elements based on the junction point between the hanger and the main cable, and the IP points at both ends as the boundary point. There are a total of 356 suspension elements in the entire bridge. The cross-sectional area, material density, and elastic modulus of the suspension element are determined according to the design values. The main beam is simplified into spatial beam elements, with a total of 10 types of cross-sections. The cross-sectional area of each beam element, the moment of inertia of the cross-section with respect to the two main axes (i.e., y-axis and x-axis), the moment of inertia of the torsion around the centroid (i.e., z-axis), the distance between the upper and lower edges of the cross-section and the centroid, and the distance between the left and right edges of the cross-section and the centroid are obtained through section analysis of the stiffened beam design. The main beam of the entire bridge is divided into 502 beam elements (nodes are set at the end face of the beam segment and the transverse partition of the main beam, and each beam segment is divided into 5-6 beam elements). The dead loads borne by the main beam element include self weight, first stage ancillary loads, and second stage ancillary loads, which are applied according to their actual positions of action (considering uniformly distributed loads within a certain bridge length range in the transverse position, uniformly distributed loads acting on the centroid, concentrated forces, etc.). The bridge tower is consolidated at a depth of 10.5 m below the base of the pier. The bridge tower is of an inverted Y-shape, with each lower branching tower column divided into 24 spatial beam elements along the tower height direction, and the upper closing tower column divided into 4 spatial beam elements along its axial direction. There are a total of 79 beam elements in the bridge tower. Sliding supports are installed at the end of the main beam at the transition pier, so constraints are directly applied. The method for determining the relevant parameters of each element is the same as that for stiffening beams. The coordinates of each node of the main beam, each node of the bridge tower, the mid-span sag of the main cable, the coordinates of the two ends of the stay cable, the coordinates of the hanger anchor points along the main beam, and the longitudinal coordinates of the hanger anchor points along the main cable in the bridge direction under the dead load state of the completed bridge are all taken as the design values. The linear expansion coefficient and elastic modulus of steel and concrete are determined based on their material properties.

The main construction steps proposed for the reasonable construction and bridge completion state determination method based on the closure section displacement difference not exceeding the allowable value are shown in Table 1. The proposed construction steps for the reasonable construction and bridge completion state determination method based on the segmented formation of the main beam (i.e. Method 2) are the remaining steps after removing construction Steps (43) and (45) in Table 1.

TABLE 1
Main construction steps of the closure scheme based on the displacement
difference of the closure section not exceeding the allowable value

| Serial number | Construction phase |
|---|---|
| 1 | Bridge tower construction |
| 2 | Installation of main cable and cable clamp |
| 3 | Installation of stay cable X1 and corresponding beam segment |
| 4-15 | Installation of stay cables X2 to X13 and corresponding beam |
| | segments |
| 16 | Installation of stay cable X14 and corresponding beam segment |
| 17 | Installation of stay cable X15 and corresponding beam segment; |
| | application of weight of bridge deck crane to the beam segment |
| | corresponding to the stay cable X15 |
| 18 | Installation of stay cable X16 and corresponding beam segment; |
| | installation of hanger D23 in place once; removal of weight of bridge |
| | deck crane acting on the beam segment corresponding to the stay |
| | cable X15, and application of weight of bridge deck crane to the beam |
| | segment corresponding to the stay cable X16 |
| 19 | Installation of stay cable X17 and corresponding beam segment; |
| | installation of hanger D22 completed in one operation; removal of |
| | weight of bridge deck crane acting on the beam segment |
| | corresponding to the stay cable X16; and application of weight of |
| | bridge deck crane to the beam segment corresponding to the stay |
| | cable X17 |
| 20 | Installation of stay cable X18 and corresponding beam segment; |
| | installation of hanger D21 completed in one operation; removal of |
| | weight of bridge deck crane acting on the beam segment |
| | corresponding to the stay cable X17; and application of weight of |
| | bridge deck crane to the beam segment corresponding to the stay |
| | cable X18 |
| 21 | Installation of fixed nodes of limit cable and main beam supports |
| 22 | Installation of limit cable |
| 23 | Installation of temporary hangers W1 and W2 and corresponding |
| | beam segments (temporary hangers W1 and W2 are installed between |
| | the beam-end support and hanger D02), and rigid connection between |
| | the beam segments |
| 24 | Installation of hanger D02 and corresponding beam segment, and |
| | hinged connection between the installed beam segment and the |
| | corresponding beam segment |
| 25-38 | Installation of hangers D03 to D16 and corresponding beam |
| | segments, with all installed beam segments connected to the |
| | previously installed adjacent segments via hinged connections |
| 39 | Installation of hangers D17 and corresponding beam segment, and |
| | hinged connection between the installed beam segment and the |
| | corresponding beam segment |
| 40 | Installation of stay cable X19 and corresponding beam segment; |
| | installation of hanger D20 completed in one operation; removal of |
| | weight of bridge deck crane acting on the beam segment |
| | corresponding to the stay cable X18, and application of weight of |
| | bridge deck crane to the beam segment corresponding to the stay |
| | cable X19 |
| 41 | Installation of stay cable X20 and corresponding beam segment; |
| | installation of hanger D19 completed in one operation; removal of |
| | weight of bridge deck crane acting on the beam segment |
| | corresponding to the stay cable X19, and application of weight of |
| | bridge deck crane to the beam segment corresponding to the stay |
| | cable X20 |
| 42 | Installation of hanger D18 and corresponding beam segment (closure |
| | section); hinged connection between the beam segment corresponding |
| | to the hanger D18 and the beam segment corresponding to the hanger |
| | D17, and arrangement of a closure section between the beam segment |
| | corresponding to the hanger D18 and the beam segment |
| | corresponding to the stay cable X20; and application of weight of |
| | bridge deck crane to the beam segment corresponding to the stay |
| | cable X20 |
| 43 | Adjustment of the closure section (adjusting length of the hangers |
| | D18-D23 and applying longitudinal force on both sides of the closure |
| | section) |
| 44 | Main beam closure (gap welding and rigid connection at the closure |
| | section) |
| 45 | Removal of the closure section adjustment measures (restoring the |
| | length of the hangers D18-D23 to a reasonable bridge stress-free |
| | length, and removing the longitudinal force on both sides of the |
| | closure section); removal of the weight of the bridge deck crane |
| | acting on the beam segment corresponding to the stay cable X20 |
| 46 | Conversion of the hinged connection of the main beam in the |
| | suspension area to rigid connection |
| 47 | Removal of the temporary hangers W1 and W2 |
| 48 | Application of Phase II dead load on the bridge deck |
| 49 | 3650-day shrinkage and creep period |

The suspension cable subsystem is a system composed of the suspension cable part specifically responsible for bearing and transmitting loads and directly related components thereof in large-scale suspension structures (especially suspension bridges), which belongs to the prior art and will not be further elaborated.

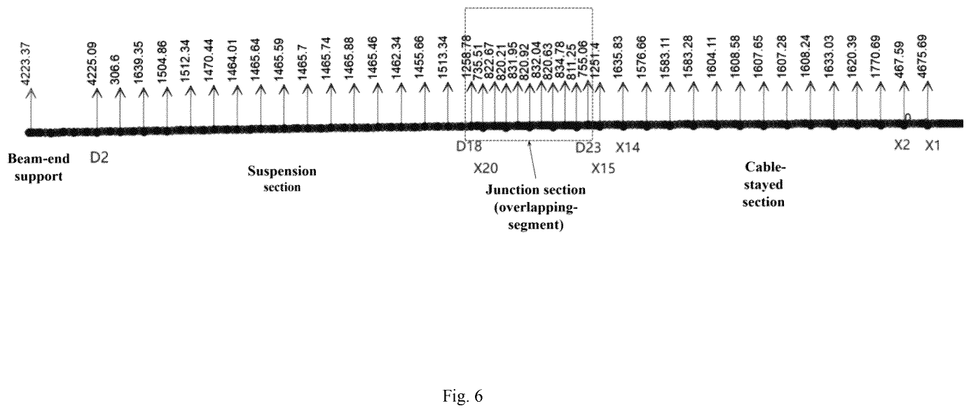

As shown in FIG. 6, in one embodiment, the step of erecting the bridge tower formwork in Step (S2) includes the following sub-steps.

(S21) Element division and node numbering: Based on the construction steps, element division of the bridge structural node numbering are performed.

Specifically, according to the proposed construction plan, the junction point (i.e. the closure section) between beam segments B22 and B21 belongs to the rod ends of two units on both sides of the closure section, and the displacement increment may be different during the construction process, thus requiring numbering as two node numbers (i.e., 236 and 10118). Similarly, beam segments B41 to B22 are hinged to each other before being fully positioned, and each junction point needs to be numbered as two different node numbers. Therefore, the finite element model of the bridge is divided into 937 elements and 1094 nodes.

(S22) Initial value assignment: The coordinates of the beam element nodes and the stress-free lengths of each cable segment of the main cable, hanger and stay cable are taken as the initial values corresponding to the weightless structure in a reasonable bridge completion state achieved by a single-step bridge formation method.

The step of initial value assignment is specifically performed as follows.

(S221) The vertical force component of the dead load in the bridge completion state at the lower end of the stay cables in the main span can be determined by using a simply-supported beam method or a rigid supported continuous beam method. Other geometric and mechanical parameters of the stay cables in the main span can be independently solved using the suspension cable subsystem.

The length of the rigid support continuous beam should include the main span and the junction section.

(S222) The horizontal force component of the dead load in the bridge completion state at the upper end of the stay cables in a side span can be determined as equal to the horizontal force component of the dead load in the bridge completion state acting on the stay cables in the main span intersecting the centerline of the bridge tower. Other geometric and mechanical parameters of each stay cable in the side span can also be independently solved according to the suspension cable subsystem.

(S223) According to the distribution ratio of dead load shared by the hangers and stay cables, the vertical force at the lower end of the hangers in the overlapping-segment is determined. The counterweight on the main beam in the cable-stayed section and the overlapping-segment of the side-span, as well as the dead load cable forces of the hangers in the main span and the side span in the bridge completion state, are determined by using the simply-supported beam method.

(S224) Based on the vertical sag of the main span and the condition that the resultant of the horizontal force components of the main cables in the main span and the side span borne by the bridge tower is zero, the geometric and mechanical parameters of the main cable and hangers in the reasonable completed bridge dead load state of both the main span and the side span are determined. The form-finding of the main cable and the calculation of stress-free lengths of each cable segment and hanger in the bridge completion state are performed independently in accordance with the suspension cable subsystem.

(S225) The obtained parameters such as the stress-free length of each cable segment, hanger, and stay cable of the main cable are integrated into the overall model of a continuous structure with a dead load and a weightless main beam. The stress-free lengths of the hanger and stay cables, as well as the coordinate model values of the beam element nodes, are determined through iterative methods, which enables the main beam and bridge tower to reach completed-bridge design alignment.

(S23) Formation of the first-stage structure with weightless beam elements: Based on the obtained stress-free lengths of each main cable segment and the node coordinates of the beam elements, a first-stage structure incorporating weightless beam elements, including main beam elements, tower elements, and main cable elements, is established. During the installation of the prefabricated beam-end segment of the cable-stayed portion, weightless beam elements of other beam segments bounded by the closure section are also installed simultaneously. Similarly, when installing the prefabricated beam-end segment of the suspension area, weightless beam elements for the remaining beam segments of the suspension area bounded by the closure section are installed simultaneously. When installing the first prefabricated tower segment, weightless beam elements for all subsequent tower segments of the bridge tower are simultaneously installed.

(S24) Formation of structures at each subsequent stage: All operations including the application of main beam weights (except for the first-stage structure), tensioning of stay cables, tensioning of hangers, hinged and rigid connections of beam segments, as well as the rigid connection of main beams on both sides after closure at each subsequent stage are performed according to the proposed construction steps, ensuring that weightless beam elements remain statically determinate under a weightless condition.

In this embodiment, the main beam that bears the self weight of the structure and the second stage dead load of the bridge deck is considered as a rigid supported continuous beam. In addition to the actual vertical support of the main beam, the actions of the hangers and stay cables on the main beam are also simplified as the vertical support of the cable anchor points on the main beam. In this way, the supporting reaction force of each support is obtained, which is the vertical component force at the lower end of the hanger or stay cable under the reasonable completed-bridge dead load state.

The distribution ratio of the dead load borne by the stay cables and hangers in the overlapping-segment calculated by the rigid supported continuous beam method may not necessarily result in optimal fatigue stress conditions for the stay cables and hangers in the overlapping-segment under traffic loads, and needs to be adjusted appropriately. This bridge has been adjusted according to the principle of consistency with the design documents, and the vertical force components at the lower ends of the hangers and stay cables in the completed-bridge dead load state are adjusted (see Table 1). According to the vertical force distribution at the lower end, coordinates of the two end points, cable properties, and cross-sectional dimensions of each stay cable under the completed-bridge dead load state, calculations are performed according to the suspension cable subsystem (one cable-stayed system is the simplest suspension cable subsystem), and the stress-free length of each stay cable under each suspension cable subsystem (see Table 2) and the cable forces at both ends of the stay cable under each suspension cable subsystem can be obtained.

TABLE 2
Vertical force of completed-bridge dead load at the lower end of hangers and stay cables, and stress-free lengths obtained by using three methods

| | | | | | | | Vertical | | | | |
|---|---|---|---|---|---|---|---|---|---|---|---|
| | Vertical | | | | | | force | | | | |
| | force | Stress-free length | | | | | at the | Stress-free length of | | | |
| | at the | of hanger (m) | | | | | lower | stay cable (m) | | | |
| | lower | | Single- | | | | end of | | Single- | | |
| | end of | | step | | | | the | | step | | |
| | the | Suspension | bridge | | | Stay | stay | Suspension | bridge | | |
| Hanger | hanger | cable | formation | | | cable | cable | cable | formation | | |
| number | (kN) | subsystem | method | Method 1 | Method 2 | number | (kN) | subsystem | method | Method 1 | Method 2 |
| Limit | 2065.1 | 51.546 | 51.546 | 51.546 | 51.546 | X1 | 3721.6 | 85.074 | 85.138 | 85.133 | 85.133 |
| cable D1 | | | | | | | | | | | |
| D02 | 1507.6 | 6.407 | 6.42 | 6.470 | 6.469 | X2 | 1773 | 97.955 | 97.784 | 97.788 | 97.788 |
| D03 | 806.3 | 7.361 | 7.356 | 7.468 | 7.468 | X3 | 1555.8 | 110.336 | 110.368 | 110.374 | 110.373 |
| D04 | 1457.8 | 8.570 | 8.57 | 8.628 | 8.629 | X4 | 1513.7 | 123.558 | 123.579 | 123.583 | 123.583 |
| D05 | 1508.6 | 10.043 | 10.041 | 10.124 | 10.127 | X5 | 1559.9 | 137.387 | 137.407 | 137.408 | 137.408 |
| D06 | 1401.7 | 11.167 | 11.169 | 11.202 | 11.206 | X6 | 1597.9 | 150.589 | 150.598 | 150.598 | 150.599 |
| D07 | 1480 | 13.077 | 13.077 | 13.137 | 13.144 | X7 | 1648.1 | 164.368 | 164.366 | 164.365 | 164.367 |
| D08 | 1472.7 | 15.203 | 15.203 | 15.236 | 15.245 | X8 | 1622.6 | 178.551 | 178.555 | 178.555 | 178.558 |
| D09 | 1470.8 | 17.539 | 17.54 | 17.589 | 17.601 | X9 | 1622.3 | 193.062 | 193.067 | 193.067 | 193.070 |
| D10 | 1471.6 | 20.089 | 20.089 | 20.118 | 20.132 | X10 | 1610.2 | 207.835 | 207.843 | 207.843 | 207.846 |
| D11 | 1471.9 | 22.853 | 22.853 | 22.893 | 22.912 | X11 | 1639.6 | 222.392 | 222.385 | 222.386 | 222.389 |
| D12 | 1472.6 | 25.831 | 25.831 | 25.855 | 25.877 | X12 | 1672.9 | 237.033 | 237.012 | 237.014 | 237.016 |
| D13 | 1473.4 | 29.023 | 29.023 | 29.055 | 29.082 | X13 | 1620.9 | 251.856 | 251.853 | 251.854 | 251.854 |
| D14 | 1475.4 | 32.429 | 32.429 | 32.447 | 32.478 | X14 | 1619.8 | 266.805 | 266.828 | 266.831 | 266.827 |
| D15 | 1483.1 | 36.049 | 36.048 | 36.070 | 36.107 | X15 | 823.6 | 282.094 | 282.345 | 282.350 | 282.341 |
| D16 | 1501.7 | 39.883 | 39.881 | 39.893 | 39.933 | X16 | 629.2 | 297.912 | 298.151 | 298.159 | 298.144 |
| D17 | 1525.3 | 43.929 | 43.93 | 43.921 | 43.967 | X17 | 623.9 | 313.279 | 313.553 | 313.561 | 313.539 |
| D18 | 1271.5 | 48.215 | 48.216 | 48.196 | 48.284 | X18 | 637.7 | 328.734 | 329.003 | 329.011 | 328.979 |
| D19 | 1087.4 | 52.710 | 52.691 | 52.688 | 52.579 | X19 | 652.5 | 344.263 | 344.524 | 344.528 | 344.488 |
| D20 | 1064.6 | 57.344 | 57.326 | 57.338 | 57.251 | X20 | 802.3 | 359.936 | 359.915 | 359.911 | 359.862 |
| D21 | 1019.2 | 62.146 | 62.131 | 62.148 | 62.084 | | | | | | |
| D22 | 1028.6 | 67.149 | 67.138 | 67.156 | 67.111 | | | | | | |
| D23 | 1690.8 | 72.289 | 72.233 | 72.247 | 72.220 | | | | | | |

Note:
The vertical force values at the lower ends of the hangers and stay cables in the Table 1 are the values corresponding to one cable; there are 3 cables at one location for hanger D1, 2 cables at one location for hangers D2 and D3, and 1 cable at one location for all other hangers and stay cables.

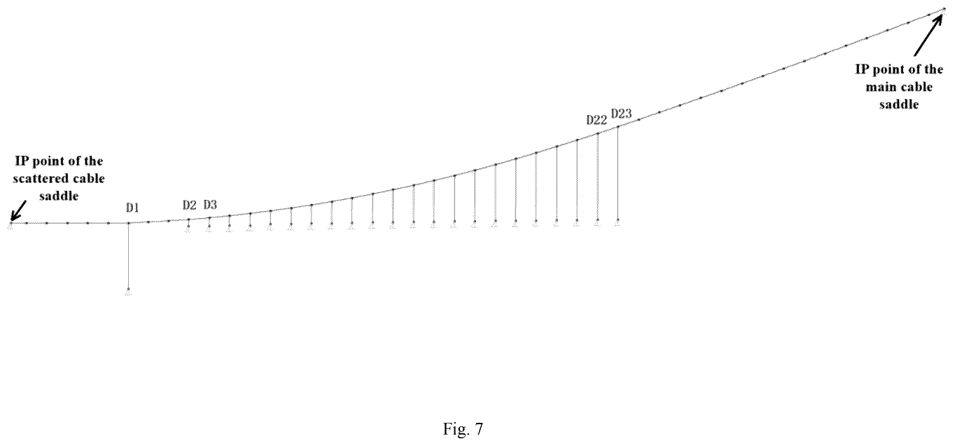

As shown in FIG. 7, in one embodiment, in Step (S224), the step of performing form-finding of the main cable and the calculation of the stress-free length of each cable segment and hanger in the bridge completion state in accordance with the suspension cable subsystem is performed as follows.

(S2241) Based on the design values of the coordinates of the lower anchor points of the hangers, the vertical force components at the lower anchor points of the hangers, and initial coordinates of the upper anchor points of the hangers, the stress-free lengths of the hangers and the cable forces at the upper anchor ends are calculated according to a catenary theory. Considering the weight of the cable clamps, the concentrated forces acting on the main cable nodes are determined.

(S2242) Based on the obtained concentrated forces acting on the main cable nodes, mid-span elevation, material properties, and cross-sectional dimensions, the coordinates of each main cable node and the stress-free length of each cable segment are calculated.

(S2243) Based on the latest coordinates of the upper anchor points of the hangers at each main cable node, the design values of the lower anchor points for each hanger, and the latest vertical component forces at the lower anchor points of the hangers, the stress-free length of each hanger, the cable forces at the upper anchor ends, and the concentrated forces acting on each main cable node are recalculated.

(S2244) The above steps are performed repeatedly. The difference between the coordinates of each node of the main cable obtained in the latest time and the coordinates of the same nodes obtained in the previous time is calculated, and it is determined whether the difference is less than the allowable value.

Specifically, in this step, if the difference is less than the allowable value, the latest data are adopted as the stress-free length of each hanger in the suspension cable subsystem and the stress-free length of each cable segment in the main cable.

If the difference is greater than the allowable value, the steps of calculating the coordinates of each node of the main cable and the stress-free length of each cable segment using analytical methods based on the concentrated forces acting on each node of the main cable, mid-span position elevation, material properties, and cross-sectional dimensions is repeated.

In this embodiment, the main cable between the IP point of the main cable saddle at the top of the tower (the fixed node of the main cable) and the IP point of the scattered cable saddle at the anchor (the fixed node of the other end of the main cable) under the completed-bridge dead load state, as well as the hanger anchored to the main beam (the fixed node), are used as the analysis model. Given the elevation of the main cable at the mid-span position, the vertical force component of each hanger at the anchor point of the main beam, and the vertical elevation shape of the hangers, the main cable form-finding and suspension cable calculation are performed. The stress-free lengths of the hangers under the suspension cable subsystem are obtained (see Table 1) and the stress-free lengths of the main cable segments (see Table 3) are obtained.

TABLE 3
Stress-free length of main cable segment

| | Stress-free |
|---|---|
| Cable | length of |
| segment | suspension |
| number | cable (m) |
| 1 | 11.973 |
| 2 | 15.964 |
| 3 | 15.964 |
| 4 | 15.964 |
| 5 | 15.965 |
| 6 | 15.965 |
| 7 | 15.490 |
| 8 | 15.493 |
| 9 | 15.995 |
| 10 | 16.018 |
| 11 | 16.037 |
| 12 | 16.058 |
| 13 | 16.082 |
| 14 | 16.107 |
| 15 | 16.136 |
| 16 | 16.167 |
| 17 | 16.200 |
| 18 | 16.237 |
| 19 | 16.275 |
| 20 | 16.317 |
| 21 | 16.360 |
| 22 | 16.406 |
| 23 | 16.455 |
| 24 | 16.507 |
| 25 | 16.562 |
| 26 | 16.612 |
| 27 | 16.657 |
| 28 | 16.704 |
| 29 | 16.750 |
| 30 | 16.799 |
| 31 | 17.083 |
| 32 | 17.097 |
| 33 | 17.110 |
| 34 | 17.123 |
| 35 | 17.137 |
| 36 | 17.151 |
| 37 | 17.164 |
| 38 | 17.178 |
| 39 | 17.192 |
| 40 | |
| 41 | 17.220 |
| 42 | 17.234 |
| 43 | 17.249 |
| 44 | 17.263 |
| 45 | 17.278 |
| 46 | 12.808 |

In one embodiment, in Step (S225), the step of determining the stress-free lengths of the hangers and stay cables, as well as the coordinate model values of the beam element nodes that enables the main beam and bridge tower to reach completed-bridge design alignment is performed as follows.

(S2251) Initial values are assigned to the stress-free coordinates of the beam element nodes and the stress-free lengths of the hangers and stay cables, as well as the vertical force components at the lower ends of the hangers in the finite element model of the entire bridge.

(S2252) A structural response of the finite element model under the single-step bridge formation considering member self-weight and secondary dead load (for example, the weight of bridge deck concrete and pavement layer, etc.), is calculated to obtain the internal forces of elements and node displacements.

(S2253) A difference between the latest vertical force components at the lower ends of the hangers under completed-bridge dead load and the previous values is calculated, and whether the difference is less than the allowable value is determined, where the allowable value tends towards 0.

Specifically, in this step, if the difference is less than the allowable value, the latest stress-free coordinates of the bridge tower and main beam nodes is added to the node displacement to obtain the calculated value of completed-bridge coordinates of the nodes.

That is, calculated completed-bridge coordinate=stress-free coordinate+displacement calculation value.

If the difference is greater than the allowable value, the stress-free length of the main cable segments and the stress-free lengths of the hangers are recalculated according to the calculation steps for the form-finding of the main cable and the stress-free length of each cable segment and hanger in the bridge completion state under the suspension cable subsystem.

(S2254) The latest stress-free coordinates of the bridge tower and main beam nodes are added to the node displacement to obtain the calculated completed-bridge coordinates of the nodes.

(S2255) A correction amount of the stress-free coordinates of the beam element nodes is determined by subtracting the calculated completed-bridge coordinates from the designed completed-bridge coordinates, and whether the correction amount of the stress-free coordinates of each node of the beam element is less than the allowable value is determined.

That is, correction amount of the stress-free coordinate=designed completed-bridge coordinate−calculated completed-bridge coordinate, and the correction amount is close to 0.

Specifically, in this step, if the correction amount is less than the allowable value, the latest stress-free coordinates of the beam element nodes and the latest stress-free lengths of the hangers and stay cables are adopted as the final stress-free coordinates of the beam element nodes and the stress-free lengths of the hangers and stay cables required to achieve the final completed-bridge design alignment under the single-step bridge formation with dead load.

If the correction amount is greater than the allowable value, the latest stress-free coordinates of the beam element nodes (i.e., the latest model coordinates of the beam element nodes) are obtained by adding the correction amount of the stress-free coordinate to the previous stress-free coordinate. Based on an unchanged cable force at the lower end of each cable and the use of latest stress-free coordinates at the two endpoints of the cable, the latest stress-free length of the hanger and stay cable is calculated according to the suspension cable subsystem.

That is, latest stress-free coordinate=previous stress-free coordinate+correction amount of the stress-free coordinate.

In this embodiment, the connecting rod ends of the main beam elements of the overall bridge model are rigidly connected, and the vertical cable forces at the lower ends of the hangers and stay cables are kept constant (see Table 2). The stress-free lengths of the main cable segments are kept constant (see Table 3). The structural displacement and stress of the overall bridge model under the single-step bridge formation with dead loads are calculated, and the stress-free lengths of the hangers and stay cables that enable the main beam and bridge tower to reach completed-bridge design alignment are determined through the iterative method (i.e., the stress-free lengths via the single-step bridge formation method), as well as the coordinate model values of the beam element nodes (i.e., the stress-free coordinates via the single-step bridge formation method).

This model converges after one iteration, and obtained stress-free lengths of the hangers and stay cables using the single-step bridge formation method are shown in Table 2. The stress-free lengths of each cable segment obtained from the main cable are shown in Table 3, and the stress-free coordinates of key nodes of beams, cables, and towers obtained from the single-step bridge formation method are shown in Table 4.

TABLE 4
Stress-free coordinates of representative nodes of main beam and bridge tower obtained through three methods

| | | Node | | | | | | | | |
|---|---|---|---|---|---|---|---|---|---|---|
| | | Longitudinal coordinate X (m) | | | Transverse coordinate Y (m) | | | Vertical coordinate Z (m) | | |
| | | Single- | | | Single- | | | Single- | | |
| | | step bridge | | | step bridge | | | step bridge | | |
| | Node | formation | | | formation | | | formation | | |
| Part | number | method | Method 1 | Method 2 | method | Method 1 | Method 2 | method | Method 1 | Method 2 |
| Main | 10026 | 12982.960 | 12982.956 | 12982.964 | 0.000 | 0.000 | 0.000 | 85.593 | 85.473 | 85.472 |
| beam | 10050 | 13046.960 | 13046.960 | 13046.957 | 0.000 | 0.000 | 0.000 | 86.627 | 86.552 | 86.545 |
| | 10074 | 13110.959 | 13110.961 | 13110.956 | 0.000 | 0.000 | 0.000 | 87.657 | 87.578 | 87.559 |
| | 10098 | 13174.959 | 13174.961 | 13174.956 | 0.000 | 0.000 | 0.000 | 88.570 | 88.481 | 88.444 |
| | 236 | 13226.959 | 13226.959 | 13227.079 | 0.000 | 0.000 | 0.000 | 89.212 | 89.144 | 89.036 |
| | 10118 | 13226.959 | 13226.959 | 13226.956 | 0.000 | 0.000 | 0.000 | 89.212 | 89.144 | 89.271 |
| | 10151 | 13302.961 | 13302.961 | 13302.960 | 0.000 | 0.000 | 0.000 | 89.958 | 89.851 | 89.878 |
| | 10173 | 13358.965 | 13358.965 | 13358.965 | 0.000 | 0.000 | 0.000 | 90.371 | 90.286 | 90.284 |
| | 10197 | 13422.974 | 13422.974 | 13422.974 | 0.000 | 0.000 | 0.000 | 90.706 | 90.644 | 90.641 |
| | 10221 | 13486.986 | 13486.986 | 13486.985 | 0.000 | 0.000 | 0.000 | 90.901 | 90.860 | 90.860 |
| Bridge | 70 | 13558.000 | 13558.000 | 13558.000 | 21.229 | 21.276 | 21.276 | 92.918 | 92.974 | 92.974 |
| tower | 72 | 13558.000 | 13558.000 | 13558.000 | 14.795 | 14.865 | 14.865 | 153.830 | 153.926 | 153.926 |
| | 82 | 13558.000 | 13558.000 | 13558.000 | 8.159 | 8.171 | 8.171 | 216.248 | 216.370 | 216.370 |
| | 92 | 13558.000 | 13558.000 | 13558.000 | 0.000 | 0.000 | 0.000 | 237.634 | 237.764 | 237.764 |
| | 96 | 13558.000 | 13558.000 | 13558.000 | 0.000 | 0.000 | 0.000 | 252.194 | 252.329 | 252.329 |

Note:
Node numbers 10026, 10050, 10074, 10098, 10151, 10173, 10197, and 10221 are the main beam nodes at anchoring positions of hangers D3, D7, D11, D15 and D23 and the stay cables X12, X8 and X4 on the small pile number side. Node numbers 236 and 10118 are the two node numbers of the main beam closure section, i.e., the node numbers of the tower-adjacent end of beam segment B22 and the tower-distant end of beam segment B21. Node numbers 70, 72, and 82 are the nodes of the lower branching tower column elements on the left side in the forward direction, where node number 70 is located near the main beam, node number 82 is the node of stay cable X10 at the anchoring position on the bridge tower, and node number 72 is located between nodes 70 and 82. Node numbers 92 and 96 are respectively the lowest and uppermost nodes of the tower column elements in the upper merging section of the bridge tower, respectively.

In one embodiment, the Step (S2251) is performed as follows.

(S22511) The designed completed-bridge coordinates of the beam element nodes are assigned as the initial values of the node coordinates in the finite element model.

(S22512) The stress-free lengths of the stay cables, the stress-free lengths of the hangers, and the stress-free lengths of the main cable segments obtained under the suspension cable subsystem are assigned as the initial values of the corresponding stress-free cable lengths in the finite element model.

(S22513) The vertical forces at the lower ends of the hangers determined by the rigid supported continuous beam method and the distribution ratio of dead load between the stay cables and the hangers in the overlapping-segment are assigned as the initial values of the vertical force components at the lower ends of the hangers for subsequent calculations.

In one embodiment, the safety inspection of each component of the completed bridge is performed, and the internal force calculation and combination of variable loads (highway level I, temperature rise of 26° C., temperature drop of 25° C.) are performed. The internal forces and stresses under the basic combination of the main control sections of the main beam are shown in Table 5, and the internal forces and stresses under the basic combination of the main control elements of the main cable, stay cables, and hangers are shown in Table 6.

TABLE 5
Internal forces and stresses under basic combination of the main control
sections of the main beam via the single-step bridge formation method

| | Maximum bending moment | | | | Minimum bending moment | | | |
|---|---|---|---|---|---|---|---|---|
| | | | Stress | Stress | | | Stress | Stress |
| | | | at the | at the | | | at the | at the |
| Main | | | upper edge | lower edge | | | upper edge | lower edge |
| beam | | | of the | of the | | | of the | of the |
| element | Axial | | cross- | cross- | Axial | | cross- | cross- |
| node | force | Moment | section | section | force | Moment | section | section |
| number | (kN) | (kN · m) | (MPa) | (MPa) | (kN) | (kN · m) | (MPa) | (MPa) |
| 10020 | 91.16 | 107970.99 | −65.21 | 95.04 | −33.56 | −25489.36 | 15.38 | −22.44 |
| 10021 | −212.42 | 91875.46 | −55.7 | 80.66 | −380.87 | −44818.72 | 26.82 | −39.7 |
| 10022 | −237.85 | 101934.23 | −61.8 | 89.49 | −340.27 | −36117.44 | 21.59 | −32.02 |
| 10034 | −757.8 | 123269.81 | −78.1 | 134.24 | −112.59 | −7997.54 | 4.94 | −8.84 |
| 10035 | −756.97 | 125199.89 | −79.31 | 136.36 | −89.85 | −6185.3 | 3.82 | −6.84 |
| 10173 | −39342.47 | 106620.77 | −89.88 | 64.24 | −57959.3 | −84031.81 | 9.55 | −111.92 |
| 10174 | −47421.3 | 91622.75 | −86.62 | 45.82 | −65538.46 | −97277.64 | 12.13 | −128.49 |
| 10175 | −47330.68 | 99407.34 | −91.14 | 52.55 | −65558.57 | −88991.12 | 7.23 | −121.4 |
| 10247 | −100162.63 | 134387.62 | −134.67 | 35.87 | −96907.26 | 14906.4 | −67.93 | −49.02 |
| 10248 | −100116.59 | 138832.26 | −137.05 | 39.13 | −96955.01 | 21191.06 | −71.37 | −44.48 |
| 10249 | −100089.03 | 140225.81 | −131.27 | 30.31 | −96971.12 | 23639.54 | −67.93 | −40.7 |

Note:
(1) The tensile stress is denoted as “+”, the compressive stress is denoted as “−”. The design values of the tensile, compressive, and bending strength of the steel box beam are fd = 270 MPa. (2) The elements in the table are main-span main beam elements on the small pile number side. The internal force (stress) of each element is the value at its tower-distant end section. The elements of each beam segment are sorted from the tower-distant end to the tower-adjacent end: 10020, 10021 and 10022 are the 3rd, 4th, and 5th main beam elements of beam segment B38, 10034 and 10035 are the 5th and 6th main beam elements of beam segment B36, 10173, 10174, and 10175 are the 2nd, 3rd, and 4th main beam elements of beam segment B13, 10247 and 10248 are the 5th and 6th main beam elements of beam segment B1, and 10249 is the 1st main beam element of beam segment B0.

TABLE 6
Internal forces and stresses under basic combination of the main control elements
of the main cable, stay cables, and hangers via the three methods

| | | | Cable force (kN) | | | Cable stress (MPa) | | | |
|---|---|---|---|---|---|---|---|---|---|
| | Cable | Cable | Single-step | | | Single-step | | | |
| | element | cross- | bridge | | | bridge | | | Allowable |
| Component | node | sectional | formation | | | formation | | | stress |
| type | number | area (m²) | method | Method 1 | Method 2 | method | Method 1 | Method 2 | (MPa) |
| Main | 10042 | 0.263571 | 235056.25 | 235857.40 | 235289.72 | 891.81 | 894.85 | 892.70 | 955 |
| cable | 10043 | 0.263571 | 235225.38 | 236028.18 | 235460.24 | 892.46 | 895.50 | 893.35 | 955 |
| | 10044 | 0.263571 | 235395.25 | 236200.31 | 235632.17 | 893.1 | 896.15 | 894.00 | 955 |
| | 10045 | 0.263571 | 235567.21 | 236372.80 | 235804.58 | 893.75 | 896.81 | 894.65 | 955 |
| | 10046 | 0.263571 | 235739.22 | 236546.87 | 235978.78 | 894.41 | 897.47 | 895.31 | 955 |
| Stay | X9 | 0.004888 | 4496.85 | 4498.43 | 4482.20 | 920.06 | 920.30 | 916.98 | 955 |
| cable | X10 | 0.004888 | 4576.62 | 4581.00 | 4564.90 | 936.39 | 937.19 | 933.90 | 955 |
| | X11 | 0.006273 | 5116.36 | 5124.35 | 5100.91 | 815.62 | 816.89 | 813.15 | 955 |
| | X12 | 0.006273 | 5472.82 | 5484.11 | 5462.00 | 872.44 | 874.24 | 870.72 | 955 |
| | X13 | 0.006273 | 5663.11 | 5914.08 | 5891.48 | 902.78 | 942.78 | 939.18 | 955 |
| Hanger | D15 | 0.0035 | 2604.15 | 2495.84 | 2493.14 | 743.6 | 713.10 | 712.33 | 955 |
| | D16 | 0.0035 | 2536.11 | 2545.07 | 2544.71 | 724.17 | 727.16 | 727.06 | 955 |
| | D17 | 0.0035 | 2657.74 | 2629.57 | 2621.99 | 758.9 | 751.31 | 749.14 | 955 |
| | D18 | 0.0035 | 1462.73 | 1522.58 | 1531.86 | 417.67 | 435.02 | 437.67 | 955 |
| | D19 | 0.0035 | 3104.46 | 3114.16 | 3007.58 | 886.46 | 889.76 | 859.31 | 955 |

Note:
The internal force and stress values in the above table are the enveloped maximum values under the basic combination.

In one embodiment, according to the proposed construction steps and the calculation process of the above embodiment, the first round of formal calculation is performed immediately prior to closure, and the results are as follows:

The longitudinal displacement difference of the beam ends on both sides of the closure section is 122 mm, the vertical displacement difference is 234 mm, and the opening amount caused by the corner is 6 mm (3000×0.002) (see Table 7 for details). Due to the displacement difference of the closure section exceeding the allowable value, the specific adjustment measures for construction Step 43 in Table 1 are obtained through trial calculation by means of the influence matrix method. The first iteration values are shown in Table 8, the stress-free anchoring lengths of D18-D23 are respectively adjusted to the corresponding values in the first iteration in Table 8, and longitudinal opposite-pulling forces are applied to the beam ends on both sides of the closure section for tension, where the opposite-pulling forces are the corresponding values in the first iteration in Table 8. After the closure is completed (i.e. the closure section is directly connected), construction Step 45 in Table 1 is performed, the hangers D18-D23 are restored to the designed stress-free lengths, and the longitudinal forces at the beam ends on both sides of the closure section are removed.

TABLE 7
Displacements and displacement differences of nodes on both sides
of the closure section before adjustment of the closure section

| | Longitudinal | Transverse | Vertical | Longitudinal |
|---|---|---|---|---|
| | displacement | displacement | displacement | angle (in |
| Node number | (m) | (m) | (m) | radians) |
| 236 | −0.094 | 0.000 | 0.889 | −0.00132 |
| 10118 | 0.029 | 0.000 | 0.655 | 0.00068 |
| Displacement | 0.122 | 0.000 | −0.234 | 0.002 |
| difference | | | | |
| (angle | | | | |
| difference) | | | | |

TABLE 8
Closure adjustment measures

| Hanger number | | D18 | D19 | D20 | D21 | D22 | D23 |
|---|---|---|---|---|---|---|---|
| Stress-free length of | First iteration | 48.216 | 52.691 | 57.326 | 62.131 | 67.138 | 72.233 |
| hanger (m) | Iteration for the | 48.203 | 52.669 | 57.304 | 62.112 | 67.124 | 72.223 |
| | second time | | | | | | |
| Adjustment length | First iteration | 0.036 | −0.170 | −0.140 | −0.115 | −0.083 | −0.050 |
| (m) | Iteration for the | 0.036 | −0.170 | −0.140 | −0.115 | −0.083 | −0.050 |
| | second time | | | | | | |
| Closure-adjusted | First iteration | 48.252 | 52.521 | 57.186 | 62.016 | 67.056 | 72.183 |
| stress-free anchoring | Iteration for the | 48.239 | 52.499 | 57.164 | 61.997 | 67.041 | 72.173 |
| length (m) | second time | | | | | | |
| Longitudinal | First iteration | 393 kN | | | | | |
| opposite-pulling | Iteration for the | 347 kN | | | | | |
| force applied to | second time | | | | | | |
| beam ends on both | | | | | | | |
| sides of the closure | | | | | | | |
| section (to eliminate | | | | | | | |
| the longitudinal | | | | | | | |
| displacement difference) | | | | | | | |

Note:
The adjustment length of the hanger is expressed as “+” for increase and “−” for decrease.

After the measures in Table 8 are adopted, the calculation is continuously performed according to the overall process. The maximum deviation between the completed-bridge elevation of the main beam and the designed completed-bridge elevation is 248 mm, which is the deviation between the bridge alignment obtained by the single-step bridge formation method and the designed alignment. The maximum elevation deviation is 5 mm, which is less than the preset allowable value of 10 mm.

The stress-free length of the stay cables and hangers obtained from the above steps are shown in Table 2. The stress-free coordinates of representative nodes of the main beam and bridge tower are shown in Table 3. The final mandatory closure measures are the corresponding second iteration values shown in Table 8. The internal forces and stresses under the basic combination of the main control sections of the main beam are shown in Table 9. The internal forces and stresses under the basic combination of the main control units of the main cable, stay cables, and hangers are shown in Table 6. The installation coordinates of rod ends of the main beam are shown in Table 10.

TABLE 9
Internal forces and stresses under basic combination of
the main control sections of the main beam in Method 1

| | Maximum bending moment | | | | Minimum bending moment | | | |
|---|---|---|---|---|---|---|---|---|
| | | | Stress at | Stress at | | | Stress at | Stress at |
| Main | | | the upper | the lower | | | the upper | the lower |
| beam | | | edge of | edge of | | | edge of | edge of |
| element | Axial | | the cross- | the cross- | Axial | | the cross- | the cross- |
| node | force | Moment | section | section | force | Moment | section | section |
| number | (Kn) | (kN · m) | (MPa) | (MPa) | (kN) | (kN · m) | (MPa) | (MPa) |
| 10020 | 84.42 | 145612.80 | −87.97 | 128.14 | −58.50 | −54568.89 | 32.95 | −48.04 |
| 10021 | −639.10 | 132332.99 | −80.47 | 115.93 | 244.00 | −69968.92 | 42.48 | −61.37 |
| 10022 | −622.23 | 144098.08 | −87.57 | 126.29 | 247.31 | −63314.52 | 38.46 | −55.51 |
| 10034 | −927.95 | 158030.04 | −100.08 | 172.13 | 735.13 | −52389.70 | 33.52 | −56.73 |
| 10035 | −907.63 | 163298.39 | −103.38 | 177.91 | 738.10 | −47933.21 | 30.72 | −51.85 |
| 10036 | −895.15 | 165047.87 | −104.47 | 179.83 | 739.28 | −45846.34 | 29.41 | −49.57 |
| 10173 | −15845.21 | 219729.62 | −140.29 | 177.33 | −46098.67 | −179878.85 | 74.15 | −185.86 |
| 10174 | −21318.08 | 207903.17 | −137.10 | 163.42 | −53384.72 | −192272.89 | 76.43 | −201.50 |
| 10175 | −21072.11 | 211169.34 | −138.85 | 166.39 | −53413.57 | −183723.41 | 71.38 | −194.19 |
| 10247 | −15939.75 | 155481.71 | −94.07 | 103.24 | −9380.75 | −31509.49 | 11.27 | −28.71 |
| 10248 | −15892.66 | 159068.23 | −95.99 | 105.88 | −9467.53 | −29944.27 | 10.37 | −27.63 |
| 10249 | −15868.43 | 160138.93 | −93.62 | 90.90 | −9466.07 | −29177.05 | 9.99 | −23.63 |

TABLE 10
Installation coordinates of rod ends for representative
segments in Method 1 and Method 2

| Main | Node | | | | | | |
|---|---|---|---|---|---|---|---|
| beam | number | Longitudinal | | Transverse | | Vertical | |
| segment | at the | coordinate X (m) | | coordinate Y (m) | | coordinate Z (m) | |
| node | element | Method | Method | Method | Method | Method | Method |
| number | end | 1 | 2 | 1 | 2 | 1 | 2 |
| B38 | 10023 | 12975.372 | 12975.366 | 0.000 | 0.000 | 88.724 | 88.721 |
| B34 | 10047 | 13039.357 | 13039.346 | 0.000 | 0.000 | 90.462 | 90.451 |
| B30 | 10071 | 13103.414 | 13103.404 | 0.000 | 0.000 | 91.501 | 91.479 |
| B26 | 10095 | 13167.517 | 13167.507 | 0.000 | 0.000 | 91.506 | 91.471 |
| B22 | 236 | 13226.865 | 13226.981 | 0.000 | 0.000 | 90.033 | 89.922 |
| B21 | 10118 | 13226.988 | 13226.986 | 0.000 | 0.000 | 89.735 | 89.865 |
| B16 | 10153 | 13306.990 | 13306.989 | 0.000 | 0.000 | 89.673 | 89.697 |
| B12 | 10177 | 13370.975 | 13370.975 | 0.000 | 0.000 | 90.736 | 90.732 |
| B7 | 10207 | 13450.981 | 13450.980 | 0.000 | 0.000 | 90.964 | 90.963 |
| B2 | 10237 | 13530.995 | 13530.995 | 0.000 | 0.000 | 91.059 | 91.059 |

Note:
Nodes 10023, 10047, 10071, 10095, and 236 are the tower-adjacent rod end nodes of the corresponding beam segments, and nodes 10118, 10153, 10177, 10207, and 10237 are the tower-distant rod end nodes of the corresponding beam segments.

The most unfavorable compressive stress of −85.92 MPa in the main beam during the construction process occurs at the bottom edge of the section of beam segment B13 in construction Step 18. The most unfavorable stresses in the hangers, stay cables, and main cable are 885.93 MPa, 602.03 MPa, and 585.87 MPa, respectively, occurring at hanger D21 in construction Step 22, stay cable X14 in construction Step 18, and the cross-section of the main cable near the tower top in construction Step 48, respectively.

In one embodiment, the allowable deviation between the calculated and designed alignment coordinates of the beam elements is set to 10 mm.

The obtained stress-free lengths of the hangers and stay cables are shown in Table 1. The stress-free coordinates of representative nodes in the main beam and the bridge tower are shown in Table 3. The internal forces and stresses under basic combination of the main control sections of the main beam are shown in Table 11. The internal forces and stresses under the basic combination of the main control elements of the main cable, stay cables, and hangers are shown in Table 5. The installation coordinates of the rod ends of the main beam segments are shown in Table 10.

The most unfavorable compressive stress of −85.77 MPa in the main beam during the construction process occurs at the bottom edge of the cross-section of the beam segment B13 in construction step 18. The most unfavorable stresses in the hangers, stay cables, and main cable are 885.76 MPa, 601.91 MPa, and 585.57 MPa, occurring at hanger D21 in construction step 22, stay cable X14 in construction Step 18, and the cross-section of the main cable near the tower top in construction Step 48, respectively.

TABLE 11
Internal forces and stresses under basic combination of main
control sections of the main beam obtained by using Method 2

| | Maximum bending moment | | | | Minimum bending moment | | | |
|---|---|---|---|---|---|---|---|---|
| | | | Stress at | Stress at | | | Stress at | Stress at |
| | | | the upper | the lower | | | the upper | the lower |
| Main beam | | | edge of | edge of | | | edge of | edge of |
| element | Axial | | the cross- | the cross- | Axial | | the cross- | the cross- |
| node | force | Moment | section | section | force | Moment | section | section |
| number | (kN) | (kN · m) | (MPa) | (MPa) | (kN) | (kN · m) | (MPa) | (MPa) |
| 10020 | 82.92 | 145279.77 | −87.77 | 127.85 | −58.89 | −53942.23 | 32.57 | −47.49 |
| 10021 | −271.80 | 131982.55 | −79.99 | 115.89 | −278.84 | −69285.62 | 41.68 | −61.15 |
| 10022 | −292.68 | 143729.50 | −87.10 | 126.21 | −237.42 | −62639.92 | 37.69 | −55.27 |
| 10034 | −756.07 | 157967.11 | −99.91 | 172.20 | 47.44 | −52078.25 | 32.78 | −56.93 |
| 10035 | −762.33 | 163269.76 | −103.25 | 177.99 | 77.10 | −47642.20 | 30.01 | −52.05 |
| 10036 | −762.98 | 165045.20 | −104.36 | 179.94 | 90.19 | −45569.56 | 28.72 | −49.78 |
| 10173 | −16082.99 | 219592.29 | −140.38 | 177.04 | −46216.91 | −178323.17 | 73.16 | −184.61 |
| 10174 | −21532.57 | 207774.44 | −137.17 | 163.17 | −53518.26 | −190727.56 | 75.43 | −200.27 |
| 10175 | −21278.36 | 211055.74 | −138.93 | 166.15 | −53555.73 | −182219.49 | 70.39 | −193.00 |
| 10247 | −16082.03 | 155147.27 | −93.98 | 102.91 | −9449.17 | −31548.44 | 11.25 | −28.78 |
| 10248 | −16032.97 | 158730.69 | −95.89 | 105.55 | −9545.68 | −29975.61 | 10.34 | −27.70 |
| 10249 | −16009.65 | 159799.60 | −93.52 | 90.61 | −9555.96 | −29202.66 | 9.95 | −23.70 |

Compared with the prior art, the construction steps of Method 1 of the present disclosure and the prior art involve the application of closure measures (adjustment of 6 pairs of hangers and application of longitudinal tension to the closure section) and the removal of closure measures after closure. However, the height difference between the ideal completed-bridge alignment of the main beam obtained by the prior art and the designed completed-bridge alignment reaches 248 mm, indicating a significant deviation. Both Method 1 and Method 2 of the present disclosure can ensure that the ideal completed-bridge alignment of the main beam is consistent with the designed alignment. Nevertheless, Method 2 of the present disclosure saves the closure measures and the removal process after closure, and improves the calculation efficiency. The specific comparison between Method 1 and Method 2 of the disclosure is as follows:

Construction measures: Compared to Method 2, Method 1 requires the additional adjustment of the stress-free anchoring lengths of six pairs of hangers D18-D23 and the application of 347 kN opposite-pulling force to the main beams on both sides of the closure section before closure, as well as the removal of these measures after closure.

Stress-free coordinates and installation coordinates of the beam and tower: The bridge tower coordinates obtained by the two methods are consistent, but the stress-free coordinates and installation coordinates of the main beam are slightly different. The closure section has a significant difference (for example, the weightless elevation of node 236 differs by −0.127 m, and the installation elevation differs by 0.110 m). The stress-free coordinates of the nodes on both sides of the closure section (node numbers 236 and 10118) obtained in Method 1 must be the same, while those obtained in Method 2 are different (see Table 4 and Table 10).

Stress-free length of hangers and stay cables: Except for the significant difference in stress-free lengths of hangers D18-D21 and stay cables X18-X20 near the closure section (hanger D19 has the maximum difference of 0.109 m, which can be ignored in terms of material consumption), there is not much difference in other places (see Table 2).

Combination stress and unfavorable stress during construction process: The difference is not significant and both meet the design strength requirements.

Calculation workload: Method 1 has increased the calculation of adjustment measures based on the displacement difference of the closure section before closure compared to Method 2.

There is not much difference in the internal forces of the bridge obtained by Method 1 and Method 2, and the structural material consumption is basically the same. However, Method 1 requires adjustment measures to be taken for the closure section, which increases materials and equipment, and the adjustment process is cumbersome and time-consuming. Method 2 does not require any adjustment measures and can automatically achieve smooth closure, which has significant economic and time benefits and is convenient for construction.

Method 2 eliminates the stringent closure condition that the displacement difference of the closure section does not exceed the allowable value, derived from the unrealistic assumption that the main beam is formed in a single phase (i.e., the stress-free state of the main beam corresponds to a continuous structure), and overcomes the limitations of Method 1, such as relatively complex erection and closure procedures. Consequently, Method 2 is comprehensive in principle and offers advantages including high computational efficiency and a streamlined construction sequence, making the determination of the beam and tower alignment as well as the tensioning forces of stay cables and hangers more intelligent.

The above description is only a preferred embodiment of the present disclosure and does not limit the patent scope of the present disclosure. Any equivalent structural transformation made under the inventive concept of the present disclosure using the contents of the present specification and drawings, or directly/indirectly applied in other related technical fields, are included in the protection scope of the present disclosure.

What is claimed is:

1. A method for intelligent determination of beam tower alignment and suspension cable tensioning of a hybrid cable-stayed suspension bridge, comprising:
(1) based on a stage-by-stage bridge construction internal logic according to a background engineering project, selecting a position of a closure section, and formulating construction steps;
(2) based on the construction steps, performing element division and node numbering on a bridge structure;
(3) assigning corresponding values of a stress-free structure under a bridge completion state achieved by single-step bridge formation as initial values of coordinates of beam element nodes and stress-free lengths of main cable segments, suspension cables and stay cables;
(4) based on the stress-free lengths of the main cable segments and the coordinates of the beam element nodes, establishing a first-stage structure comprising weightless beam elements, wherein the weightless beam elements comprise main beam elements, tower elements and the main cable elements;
during installation of a prefabricated beam-end segment in a cable-stayed portion, simultaneously installing weightless beam elements of remaining beam segments in the cable-stayed portion bounded by the closure section;
during installation of a prefabricated beam-end segment of a suspension area, simultaneously installing weightless beam elements of remaining beam segments in the suspension area bounded by the closure section; and
during installation of a first prefabricated tower segment, simultaneously installing weightless beam elements of remaining tower segments of the bridge tower;
(5) for all stages except the first-stage structure, performing application of main beam weights, tensioning of the stay cables, tensioning of the suspension cables, hinged and rigid connections of beam segments and rigid connection of main beams on both sides after closure according to the construction steps, ensuring that weightless beam elements remain statically determinate under a weightless condition;
(6) performing formal calculation on beam closure according to the construction steps;
(7) determining whether a displacement difference between nodes on both sides of the closure section immediately prior to closure is less than a first allowable value;
(8) performing calculation from a closure moment to bridge completion or up to 10 years after the bridge completion;
(9) calculating and combining internal forces under variable loads in the bridge completion state;
(10) determining whether a bearing capacity during a construction phase and a bearing capacity of a completed bridge meet design and specification requirements;
(11) calculating bridge coordinate values for the beam element nodes, wherein a calculated coordinate of one of the beam element nodes is equal to a latest coordinate model value of a corresponding node plus a cumulative displacement value of the corresponding node;
(12) determining whether a deviation between calculated coordinates and design values of the beam element nodes is less than a second allowable value;
(13) based on the bridge bearing capacity of the completed bridge, the calculated coordinates of the beam element nodes, and the stress-free lengths of the main cable segments, performing, by using a suspension cable subsystem, form-finding calculation on the main cable to obtain a calculated sag of the main cable in the bridge completion state; and calculating a difference between a designed sag and the calculated sag of the main cable, and determining whether the difference between the designed sag and the calculated sag is greater than a third allowable value;
(14) determining stress-free coordinates and installation coordinates of beam tower nodes based on final coordinate model values and a corresponding node displacement to an installation time; and
(15) performing variable load effect calculation, internal force combination and verification.

2. The method of claim 1, wherein step (3) comprises:
determining, by using a simply-supported beam method or a rigid supported continuous beam method, a vertical force component of a dead load in the bridge completion state acting on lower ends of stay cables in a main span; and independently solving, by using the suspension cable subsystem, other geometric and mechanical parameters of the stay cables in the main span;
determining a horizontal force component of the dead load acting on upper ends of stay cables in a side span as equal to a horizontal force component of the dead load in the bridge completion state acting on the stay cables in the main span intersecting a centerline of the bridge tower; and independently solving, by using the suspension cable subsystem, other geometric and mechanical parameters of the stay cable in the side span;
according to a distribution ratio of the dead load shared by the suspension cables and the stay cables, determining a vertical force at lower ends of suspension cables in an overlapping-segment; and determining, by using a simply-supported beam method, a counterweight on the main beam in a cable-stayed section and the overlapping-segment of the side-span and dead load cable forces of the suspension cables in the main span and the side span in the bridge completion state;
based on a vertical sag of the main span and a condition that a resultant of horizontal force components of the main cables in the main span and the side span borne by the bridge tower is zero, determining geometric and mechanical parameters of the main cable and the suspension cables in the completed bridge dead load state of the main span and the side span; performing form-finding of the main cable and calculation of stress-free lengths of the cable segments and the suspension cables in the bridge completion state in accordance with the suspension cable subsystem; and
integrating the stress-free lengths of the cable segments, the suspension cables and the stay cables of the main cable into an overall model of a continuous structure with a dead load and a weightless main beam; and determining, through an iterative method, the stress-free lengths of the suspension cables and the stay cables, as well as coordinate model values of the beam element nodes to achieve completed-bridge design alignment for the main beam and the bridge tower.

3. The method of claim 2, wherein the step of performing form-finding of the main cable and calculation of the stress-free lengths of the cable segments and the suspension cables in the bridge completion state in accordance with the suspension cable subsystem comprises:
(a) based on design values of coordinates of lower anchor points of the suspension cables, vertical force components at the lower anchor points and initial coordinates of upper anchor points of the suspension cables, calculating the stress-free lengths of the suspension cables and the cable forces at the upper anchor ends according to a catenary theory, and determining concentrated forces acting on the main cable nodes considering a weight of a cable clamp;
(b) based on the concentrated forces, mid-span elevation, material properties and cross-sectional dimensions, calculating, by using an analytical method, coordinates of each main cable node and the stress-free length of each cable segment;
(c) based on latest coordinates of the upper anchor points at each main cable node, the design values of the lower anchor points for each suspension cable and latest vertical component forces at the lower anchor points, recalculating the stress-free length of each suspension cable, the cable force at the upper anchor end, and the concentrated forces acting on each main cable node;
(d) repeatedly performing steps (a)-(c), after each iteration, calculating a difference between coordinates of each node of the main cable obtained in the latest time and coordinates of the same nodes obtained in the previous time, and determining whether the difference is less than a fourth allowable value;
(e) if the difference is less than the fourth allowable value, adopting the latest values of stress-free lengths the suspension cables and main cable segments as final design values; and
(f) if the difference is greater than the fourth allowable value, repeating step (b).

4. The method of claim 2, wherein the steps of determining, through the iterative method, the stress-free lengths of the suspension cables and the stay cables, as well as coordinate model values of the beam element nodes to achieve completed-bridge design alignment for the main beam and the bridge tower comprises:
(a) assigning initial values to the stress-free coordinates of the beam element nodes and the stress-free lengths of the suspension cables and the stay cables, as well as the vertical force components at the lower ends of the suspension cables in the finite element model of the entire bridge;
(b) calculating a structural response of the finite element model under the single-step bridge formation considering member self-weight and secondary dead load to obtain internal forces of elements and nodal displacements;
(c) calculating a difference between the latest vertical force components at the lower ends of the suspension cables under the completed-bridge dead load and previous values, and determining whether the difference is less than a fourth allowable value;
(d) if the difference is less than the fourth allowable value, adding the latest stress-free coordinates of the bridge tower and main beam nodes to the node displacement to obtain calculated bridge coordinates of the nodes;
(e) if the difference is greater than the allowable value, recalculating the stress-free length of the main cable segments and the stress-free length of the suspension cables according to the calculation steps for the form-finding of the main cable and the stress-free length of each cable segment and suspension cable in the bridge completion state under the suspension cable subsystem;
(f) adding the latest stress-free coordinates of the bridge tower and the main beam nodes to the node displacement to obtain the calculated completed-bridge bridge coordinates of the nodes;
(g) determining a correction amount of the stress-free coordinates of the beam element nodes by subtracting the calculated bridge-completed coordinates from the designed bridge-completed coordinates, and determining whether the correction amount is less than a fifth allowable value;
(h) if the correction amount is less than the fifth allowable value, adopting the latest stress-free coordinates of the beam element nodes and latest stress-free lengths of the suspension cables and the stay cables as the final stress-free coordinates of the beam element nodes and the stress-free lengths of the suspension cables and the stay cables required to achieve final completed-bridge design alignment under the single-step bridge formation with the dead load; and
(i) if the correction amount is greater than the fifth allowable value, adding the correction amount to the previous stress-free coordinates to obtain the latest stress-free coordinates of the beam element nodes, and calculating latest stress-free lengths of the suspension cables and the stay cables according to the suspension cable subsystem based on an unchanged cable force at the lower end of each cable and the latest stress-free coordinates at the two endpoints of the cable.

5. The method of claim 4, wherein step (a) comprises:
assigning the bridge coordinate design values of the beam element nodes as initial values node coordinates in the finite element model;
assigning the stress-free lengths of the stay cables, the stress-free lengths of the suspension cables, and the stress-free lengths of the main cable segments obtained under the suspension cable subsystem as initial values of corresponding stress-free cable lengths in the finite element model; and
determining vertical forces at the lower ends of the suspension cables by the rigid supported continuous beam method and the distribution ratio of dead load between the stay cables and the suspension cables in the overlapping-segment as initial values of the vertical force components at the lower ends of the suspension cables for subsequent calculations.

6. The method of claim 1, wherein step (7) comprises:
if the displacement difference is less than the first allowable value, proceeding internal force calculation and combination under variable loads until the bridge completion or up to 10 years after the bridge completion followed by strength determination; and
if the displacement difference is greater than the first allowable value, adjusting the closure section and repeating steps of forming the structural model.

7. The method of claim 1, wherein step (10) comprises:
if the requirements are met, calculating the coordinates of the beam element nodes; and
if the requirements are not met, adjusting the construction steps or tensioning forces of the suspension cables and the stay cables, and repeating the step of forming the first-stage structure using weightless beam elements.

8. The method of claim 1, wherein step (12) comprises:
if the deviation is less than the second allowable value, performing main cable completed-bridge alignment verification calculation; and
if the deviation is greater than the second allowable value, calculating a correction amount of model coordinate values of the beam element nodes, wherein the correction amount is equal to a design value of a completed bridge coordinate of a corresponding one of the beam element nodes minus the latest calculated value of the completed bridge coordinate of the corresponding one of the beam element nodes, then calculating a latest coordinate model value by adding the correction amount to a previous coordinate model value of the corresponding one of the beam element nodes; based on the latest coordinate model value and the vertical force components at the lower ends of the suspension cables and the stay cables, adjusting the stress-free lengths of the suspension cables and the stay cables, and repeating the step of forming the first-stage structure using weightless beam elements.

9. The method of claim 1, wherein the step of determining whether the difference between the designed sag and the designed sag is greater than the third allowable value comprises:
if the difference is less than the allowable value, determining installation coordinates; and
if the difference is greater than the allowable value, based on the latest suspension cable force, the coordinates of the anchor points, and the designed sag in the bridge completion state, recalculating the stress-free lengths of the main cable segments using the suspension cable subsystem, and repeating the step of forming the first-stage structure comprising the weightless beam elements.

10. A method for intelligent determination of beam tower alignment and suspension cable tensioning of a hybrid cable-stayed suspension bridge, comprising:
(1) based on a stage-by-stage bridge construction internal logic according to a background engineering project, selecting a position of a closure section, and formulating construction steps;
(2) based on the construction steps, performing element division and node numbering on a bridge structure;
(3) assigning corresponding values of a stress-free structure under a bridge completion state achieved by single-step bridge formation as initial values of coordinates of beam element nodes and stress-free lengths of main cable segments, hangers and stay cables;
(4) based on the stress-free lengths of the main cable segments and the coordinates of the beam element nodes, establishing a first-stage structure comprising weightless beam elements, wherein the weightless beam elements comprise main beam elements, tower elements and the main cable elements;
during installation of a prefabricated beam-end segment in a cable-stayed portion, simultaneously installing weightless beam elements of remaining beam segments in the cable-stayed portion bounded by the closure section;
during installation of a prefabricated beam-end segment of a suspension area, simultaneously installing weightless beam elements of remaining beam segments in the suspension area bounded by the closure section; and
during installation of a first prefabricated tower segment, simultaneously installing weightless beam elements of remaining tower segments of the bridge tower;
(5) for all stages except the first-stage structure, performing application of main beam weights, tensioning of the stay cables, tensioning of the hangers, hinged and rigid connections of beam segments and rigid connection of main beams on both sides after closure according to the construction steps, ensuring that weightless beam elements remain statically determinate under a weightless condition;
(6) performing calculation from a closure moment to bridge completion or up to 10 years after the bridge completion;
(7) calculating and combining internal forces under variable loads in the bridge completion state;
(8) determining whether a bearing capacity during a construction phase and a bearing capacity of a completed bridge meet design and specification requirements;
(9) calculating bridge coordinate values for the beam element nodes, wherein a calculated coordinate of one of the beam element nodes is equal to a latest coordinate model value of a corresponding node plus a cumulative displacement value of the corresponding node;
(10) determining whether a deviation between calculated coordinates and design values of the beam element nodes is less than a second allowable value;
(11) based on the bridge bearing capacity of the completed bridge, the calculated coordinates of the beam element nodes, and the stress-free lengths of the main cable segments, performing, by using a suspension cable subsystem, form-finding calculation on the main cable to obtain a calculated sag of the main cable in the bridge completion state; and calculating a difference between a designed sag and the calculated sag of the main cable, and determining whether the difference between the designed sag and the calculated sag is greater than a third allowable value;
(12) determining stress-free coordinates and installation coordinates of beam tower nodes based on final coordinate model values and a corresponding node displacement to an installation time; and
(13) performing variable load effect calculation, internal force combination and verification.
